(19) United States
(12) Patent Application Publication
(10) Pub. No.: US 2013/0205112 A1
(43) Pub. Date: Aug. 8, 2013

(54) METHOD AND A DEVICE FOR CONTROLLING MEMORY ALLOCATION

(71) Applicant: TELLABS OY, Espoo (FI)

(72) Inventors: Ville HALLIVUORI, Espoo (FI); Juhamatti KUUSISAARI, Helsinki (FI)

(73) Assignee: TELLABS OY, Espoo (FI)

(21) Appl. No.: 13/757,936

(22) Filed: Feb. 4, 2013

(30) Foreign Application Priority Data
Feb. 3, 2012 (FI) 20125118

(51) Int. Cl. G06F 12/02

(52) U.S. Cl. CPC G06F 12/023
USPC 711/170

(57) ABSTRACT

The invention relates to allocating and releasing a memory organized to contain memory block groups each of which containing memory blocks. There is a first data entity (101) that indicates the number of free memory blocks in each memory block group. For each memory block group, there is a second data entity (102, 103, . . . , 105) that indicates which of the memory blocks of the concerned memory block group are free. When a request to allocate a memory block is received, a memory block group containing a free memory block is searched on the basis of the first data entity and, from this memory block group, a free memory block is searched on the basis of the second data entity relating to this memory block group. The first data entity and the second data entities constitute a compact data structure, and therefore a cache memory can be effectively utilized.

### FIELD OF THE INVENTION

The invention relates to a method and to a device for controlling allocation of memory blocks of a memory organized to contain a plurality of memory block groups each of which containing a plurality of memory blocks. Furthermore, the invention relates to a computer program for controlling allocation of memory blocks of a memory.

### BACKGROUND

In many electronic devices which comprise a memory and a processor there is a need to allocate parts of the memory for some purposes of use, and later release the allocated parts when they are no more needed for these purposes of use. Network elements such as routers, switches, and bridges are examples of electrical of devices of the kind mentioned above. A network element receives data frames, stores and processes the received data frames, and finally forwards the data frames to data transfer links which connect the network element to other network elements. Many network elements comprise one or more such memories which are organized to contain a plurality of memory block groups each of which containing a plurality of memory blocks. A single memory block can be allocated, for example, for storing a data frame, or a part of it, which is queuing up for being processed or forwarded. A process that controls the allocation of the memory blocks receives, from another process that uses the memory, a request to allocate one or more memory blocks and, in response to this request, returns one or more addresses which identify the allocated one or more memory blocks. When the allocated memory blocks are no more needed, the process using the memory returns one or more addresses which identify the memory blocks that can be released to wait for further use. The process for controlling the allocation of the memory blocks is frequently in use, and thus the process should be such that a cache memory is effectively utilized. In typical methods for controlling the memory allocation, this is however not the case because pointers which indicate the locations of free and allocated memory blocks are situated in conjunction with the memory blocks, and thus these pointers are located in a distributed way in the address space of the memory. Therefore, data items which are used in successive allocation or releasing operations can be located relatively far from each other in the address space. Thus, it is typical that the cache memory contains data which is used only once or twice and, before the next usage of this data, a lot of other data is used and loaded to the cache memory and therefore the first mentioned data may be dropped out from the cache memory before its next usage. As a corollary, the cache memory is not effectively utilized.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the first aspect of the invention there is provided a new device for controlling a memory organized to contain a plurality of memory block groups each of which containing a plurality of memory blocks. The device according to the invention comprises a processor configured to:
maintain a first data entity containing first data items so that there is a first data item for each of the memory block groups, each of the first data items indicating how many free memory blocks there are in the memory block group related to this first data item, and
maintain second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among all the memory blocks of the memory block group related to this second data entity.

The processor is further configured to carry out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming an address identifying the free memory block to be allocated at least partly on the basis of (i) the searched first data item which indicates the memory block group having at least one free memory block and (ii) the indicator of the free memory block, and
updating the searched first data item to correspond to a situation in which the number of free memory blocks in the memory block group related to the searched first data item has decreased by one.

In a device according to an advantageous and exemplifying embodiment of the present invention, the processor is further configured to carry out the following actions in response to receiving an address identifying a memory block to be released from allocation:
determining the memory block group which contains the memory block to be released,
updating the first data item related to the determined memory block group by adding one to the number of free memory blocks of the determined memory block group,
determining an indicator which identifies, from among all the memory blocks of the determined memory block group, the memory block to be released,
determining, from the second data entity related to the determined memory block group, such a second data item which does not contain an indicator of any other memory block that is free, and
setting the determined second data item to contain the indicator which identifies, from among all the memory blocks of the determined memory block group, the memory block to be released.

The above-mentioned first data entity that contains the first data items is used in every allocation and releasing operation. Thus, at each allocation or releasing operation, the first data entity can be found from a cache memory with a very high probability. Also the second data entities can be arranged to constitute a compact data set because each second data item can be a data element of only few bits. Hence, at each allocation or releasing operation, also the second data entity relating to the memory block group under consideration can be found from the cache memory with a good probability.

For example, in a case where there are e.g. 48 memory block groups each containing e.g. 15 memory blocks, each first data item can be four bits and also each second data item can be four bits. In this exemplifying case, the size of the first data entity is 48×4 bits which is 24 bytes, and the size of each second data entity is 15×4 bits which is less than 8 bytes. In a case where a cache line is e.g. 32 bytes, the first data entity fits in a single cache line and four second data entities fit in a single cache line. The whole data structure, i.e. the first data entity and the 48 second data entities, fits in only 13 cache lines. Thus, cache misses are very improbable in allocation and releasing operations, and therefore the cache memory can be effectively utilized.

In accordance with the second aspect of the invention there is provided a new method for controlling a memory organized to contain a plurality of memory block groups each of which containing a plurality of memory blocks. The method according to the invention comprises:
maintaining a first data entity containing first data items so that there is a first data item for each of the memory block groups, each of the first data items indicating how many free memory blocks there are in the memory block group related to this first data item, and
maintaining second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this sec- and data entity are free, one or more of the second data items of this second data entity contain indicators identifying the free memory blocks from among the memory blocks of the memory block group related to this second data entity.

The method further comprises carrying out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming a first address identifying the free memory block to be allocated at least partly on the basis of (i) the searched first data item which indicates the memory block group having at least one free memory block and (ii) the indicator of the free memory block, and
updating the searched first data item to correspond to a situation in which the number of free memory blocks in the memory block group related to the searched first data item has decreased by one.

A method according to an advantageous and exemplifying embodiment of the present invention further comprises carrying out the following actions in response to receiving an address identifying a memory block to be released from allocation:
determining the memory block group which contains the memory block to be released,
updating the first data item related to the determined memory block group by adding one to the number of free memory blocks in the determined memory block group,
determining an indicator which identifies, from among the memory blocks of the determined memory block group, the memory block to be released,
determining, from the second data entity related to the determined memory block group, such a second data item which does not contain an indicator of any other memory block that is free, and
setting the determined second data item to contain the indicator which identifies, from among the memory blocks of the determined memory block group, the memory block to be released.

In accordance with the third aspect of the invention there is provided a new computer program for controlling a memory organized to contain a plurality of memory block groups each of which containing a plurality of memory blocks. The computer program according to the invention comprises computer executable instructions for controlling a programmable processor to:
maintain a first data entity containing first data items so that there is a first data item for each of the memory block groups, each of the first data items indicating how many free memory blocks there are in the memory block group related to this first data item, and
maintain second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity.

The computer program further comprises computer executable instructions for controlling the programmable processor to carry out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming a first address identifying the free memory block to be allocated at least partly on the basis of (i) the searched first data item which indicates the memory block group having at least one free memory block and (ii) the indicator of the free memory block, and
updating the searched first data item to correspond to a situation in which the number of free memory blocks in the memory block group related to the searched first data item has decreased by one.

A computer program according to an advantageous and exemplifying embodiment of the present invention further comprises computer executable instructions for controlling the programmable processor to carry out the following actions in response to receiving an address identifying a memory block to be released from allocation:
determining the memory block group which contains the memory block to be released,
updating the first data item related to the determined memory block group by adding one to the number of free memory blocks in the determined memory block group,
determining an indicator which identifies, from among the memory blocks of the determined memory block group, the memory block to be released,
determining, from the second data entity related to the determined memory block group, such a second data item which does not contain an indicator of any other memory block that is free, and
setting the determined second data item to contain the indicator which identifies, from among the memory blocks of the determined memory block group, the memory block to be released.

In accordance with the fourth aspect of the invention there is provided a new computer program product. The computer program product comprises a non-volatile computer readable medium, e.g. a compact disc “CD”, encoded with a computer program according to the invention.

A number of exemplifying embodiments of the invention are described in accompanied dependent claims.

Various exemplifying embodiments of the invention both as to constructions and to methods of operation, together with additional objects and advantages thereof, will be best understood from the following description of specific exemplifying embodiments when read in connection with the accompanying drawings.

The verb “to comprise” is used in this document as an open limitation that neither excludes nor requires the existence of also un-recited features. The features recited in depending claims are mutually freely combinable unless otherwise explicitly stated.

### BRIEF DESCRIPTION OF THE FIGURES

The exemplifying embodiments of the invention and their advantages are explained in greater detail below with reference to the accompanying drawings, in which:

FIG. 1 shows a schematic illustration of a data structure according to an exemplifying embodiment of the invention for controlling memory allocation,

FIG. 2 shows a schematic illustration of a device according to an exemplifying embodiment of the invention for controlling memory allocation, and

FIG. 3 shows a flow chart of a method according to an exemplifying embodiment of the invention for controlling memory allocation.

### DESCRIPTION OF THE EXEMPLIFYING EMBODIMENTS

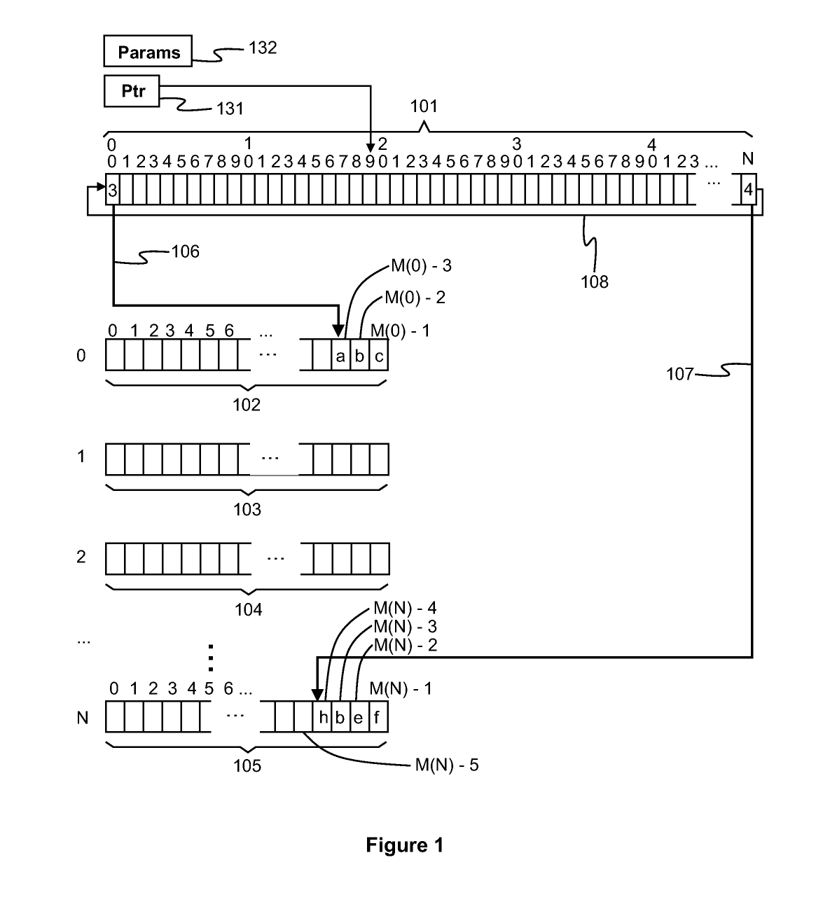

FIG. 1 shows a schematic illustration of a data structure according to an exemplifying embodiment of the invention for controlling memory allocation. The memory is organized to contain a plurality of memory block groups each of which containing a plurality of memory blocks. The memory block groups are sometimes called “pipelines”. In this exemplifying case, the memory has N+1 memory block groups. The data structure comprises a first data entity 101 that contains first data items so that there is one first data item for each of the memory block groups. Hence, in this exemplifying case, there are N+1 first data items in the first data entity 101. Each of the first data items indicates a number of free memory blocks in the memory block group related to this first data item. In the exemplifying case illustrated in FIG. 1, there are three free memory blocks in the memory block group related to the first data item ‘0’ and four free memory blocks in the memory block group related to the first data item ‘N’.

The data structure comprises N+1 second data entities 102, 103, . . . , 105 so that there is one second data entity for each of the N+1 memory block groups. Each of the second data entities contains second data items so that the number of the second data items in each second data entity is at least the number of the memory blocks in the memory block group related to this second data entity. For example, the memory block group related to the first data item ‘0’ and to the second data entity ‘0’ contains M(0) memory blocks and thus the second data entity ‘0’ contains at least M(0) second data items, and correspondingly, the memory block group related to the first data item ‘N’ and to the second data entity ‘N’ contains M(N) memory blocks and thus the second data entity ‘N’ contains at least M(N) second data items. However, it is usually advantageous that all the memory block groups contain a same number of memory blocks.

When one or more of the memory blocks of a given memory block group are free, one or more of the second data items of the corresponding second data entity contain indicators identifying the free memory blocks from among all the memory blocks of this memory block group. In the exemplifying case illustrated in FIG. 1, there are three free memory blocks in the memory block group related to the first data item ‘0’ and four free memory blocks in the memory block group related to the first data item ‘N’. The second data items ‘M(0)-3’, ‘M(0)-2’, and ‘M(0)-1’ of the second data entity 102 contain ‘a’, ‘b’, and ‘c’, respectively, which are the indicators of these three free memory blocks. Correspondingly, the second data items ‘M(N)-4’, ‘M(N)-3’, ‘M(N)-2’, and ‘M(N)-1’ of the second data entity 105 contain ‘h’, ‘b’, ‘e’, and ‘c’, respectively, which are the indicators of the four free memory blocks in the memory block group related to the first data item ‘N’.

When a request to allocate a free memory block has been received, such a first data item that indicates that there is at least one free memory block in the corresponding the memory block group is searched from the first data entity 101. This search can be, for example, a linear search starting from the first data item ‘0’, but it should be noted that this is not the only possible choice. For another example, the first data entity 101 can be arranged to be a logical ring so that each first data item has a predecessor and a successor in the logical ring, and the data structure comprises a pointer 131 indicating, from the logical ring, such a first data item that relates to the memory block group that contains a previously-allocated memory block. The search is started from a first data item that is indicated by the pointer 131. In FIG. 1, the logical ring is illustrated with an arrow 108 which shows that the successor of the first data item ‘N’ is the first data item ‘0’.

In the exemplifying case illustrated in FIG. 1, the first data item ‘0’ indicates that there are three free memory blocks in the memory block group related to the first data item ‘0’. Next, such a second data entity, which is related to the memory block group related to the first data item ‘0’, is selected from among all the second data entities. In the exemplifying case illustrated in FIG. 1, the second data entity 102 is related to the memory block group related to the first data item ‘0’. From the selected second data entity 102, such a second data item which carries an indicator of a free memory block is selected. In the exemplifying case illustrated in FIG. 1, each second data entity is presented as an ordered list of the second data items and the indicators of free memory blocks are placed at the end of the ordered list. Hence, in a case where a given first data item is ‘n’, one can know that n last second data items of the corresponding second data entity are indicators of free memory blocks. Thus, the first data item is actually a pointer that points to the ordered list so that the pointed second data item and the second data items that are successive in the ordered list contain indicators of free memory blocks. In FIG. 1, the pointer interpretation of the first data item is illustrated with arrows 106 and 107. In the exemplifying case illustrated in FIG. 1, the second data item ‘M(0)-3’ that is pointed by the first data item ‘0’ can be selected from among all the second data items of the second data entity 102. Hence, the free memory block to be allocated is the memory block that is identified by the indicator ‘a’. Next, the first data item ‘0’ is decreased by one down to 2 and, as a corollary, the arrow 106 is shifted to point to the second data item ‘M(0)-2’ of the second data entity 102.

It should be noted that arranging the second data entities in ordered lists, where the indicators of free memory blocks are placed at the ends of the ordered lists, is not the only possible choice. The indicators of free memory blocks can be handled in the second data entities according to various pre-determined principles. For example, each second data entity can be an ordered list and the indicators of free memory blocks can be placed at the beginning of the ordered list. For another example, each second data entity can be a logical ring and there can be a ring pointer that points to the first one or to the last one of those second data items which contain the indicator of free memory blocks.

An address that identifies the free memory block being allocated is formed at least partly on the basis of (i) the searched first data item ‘0’ which indicates the memory block group having at least one free memory block and (ii) the indicator ‘a’ which identifies the said free memory block from among all the memory blocks of the memory block group under consideration. The address can be, for example, the address of the first row of the memory block being allocated.

Advantageously, the memory block groups are consecutively numbered, and, within each memory block group, the memory blocks are consecutively numbered. In this case, the indicator ‘a’ which identifies the free memory block is advantageously the number of this memory block. For the sake of illustration, we consider a special case where each memory block group has a same number of memory blocks, each memory block has a same size, the memory block groups are located at regular intervals in the address space of the memory, and, within each memory block group, the memory blocks are located at regular intervals in the address space. In this case, the address Addr₁ identifying the memory block being allocated can be formed according to the formula:

Addr₁=k_{BG1}x S_{BG}+k_{B1}×S_{B}+C, (1)

where k_{BG1} is the number of the memory block group related to the searched first data entity, k_{B1} is the number of the free memory block being allocated, i.e. the indicator identifying this memory block, S_{BG} is a difference of mutually corresponding addresses of two successive memory block groups, S_{B} is a difference of mutually corresponding addresses of two successive memory blocks in the memory block group related to the searched first data entity, and C is an offset control parameter which is the value of Addr₁ in the situation where S_{BG}=S_{B}=0. The mutually corresponding addresses of the two successive memory block groups can be the addresses of the first rows of the first memory blocks of the two successive memory block groups, and the mutually corresponding addresses of the two successive memory blocks can be the addresses of the first rows of the two successive memory blocks. S_{BG} is the length of the address range of the memory block group when there are no gaps between successive memory block groups. Correspondingly, S_{B} is the length of the address range of the memory block when there are no gaps between successive memory blocks. The formula (1) is straightforward to understand when the memory block groups are consecutively numbered starting from zero, and, within each memory block group, the memory blocks are consecutively numbered starting from zero. In this case, the offset control parameter C can be a base-address which is the address of the first row of the memory block ‘0’ of the memory block group ‘0’. The data structure may further comprise one or more parameters 132 which indicate the above-mentioned S_{BG} and/or S_{B} and/or the base address.

After the address that identifies the memory block being allocated has been formed, it can be delivered to a process from which the request to allocate a free memory block was received. This process can be, for example, a process for queuing and de-queuing data frames, e.g. Internet Protocol “IP” data packets.

When an address identifying a memory block to be released from allocation has been received, the memory block group which contains the memory block to be released is determined on the basis of the said address and information about how the memory has been organized into memory block groups. In this exemplifying case, we assume that the memory block group which contains the memory block to be released is the memory block group related to the first data item ‘N’. Next, the first data item ‘N’ is increased by one up to 5 and, as a corollary, the arrow 107 is shifted to point to the second data item ‘M(N)-5’ of the second data entity 105. An indicator identifying the memory block to be released is determined on the basis of the above-mentioned address and information about how the determined memory block group has been organized into memory blocks. This indicator identifies this memory block from among all the memory blocks of the determined memory block group. Next, an appropriate second data item of the second data entity 105 is updated to contain the indicator identifying the memory block to be released. The first data item ‘N’ was four prior to its above-described update, and thus the second data item ‘M(N)-5’ of the second data entity 105 does not contain an indicator of any other free memory block. Therefore this second data item ‘M(N)-5’ can be used for storing the indicator identifying the memory block to be released. The releasing operation is completed by setting the second data item ‘M(N)-5’ of the second data entity 105 to contain the indicator identifying the memory block to be released.

For the sake of illustration, we consider the special case where each memory block group has a same number of memory blocks, each memory block has a same size, the memory block groups are located at regular intervals in the address space of the memory, and, within each memory block group, the memory blocks are located at regular intervals in the address space. We further assume that the memory block groups are consecutively numbered starting from zero, and, within each memory block group, the memory blocks are consecutively numbered starting from zero. In this case, the number k_{BG2} of the memory block group, which contains the memory block to be released, can be obtained from the following formula:

$${k}_{BG 2} = the integer part of ( \frac{{Addr}_{2} - C}{{S}_{BG}} ) , \qquad ( 2 )$$

where Addr₂ is the address identifying the memory block to be released, and “the integer part of” is the greatest integer that is less than or equal to the value under consideration. For example, the integer part of 3.14 is 3 and the integer part of 4.999 is 4. The S_{BG} is the difference of mutually corresponding addresses of two successive memory block groups as in conjunction with the formula (1), and C is the same offset control parameter as in conjunction with the formula (1). The number k_{B2} of the memory block to be released can be obtained from the following formula:

$${k}_{B 2} = \frac{{Addr}_{2} - {k}_{BG 2} \times {S}_{BG} - C}{{S}_{B}} , \qquad ( 3 )$$

where S_{B} is a difference of mutually corresponding addresses of two successive memory blocks as in conjunction with the formula (1).

It should be noted that embodiments of the present invention are not limited to the above-mentioned special case where each memory block group has a same number of memory blocks, each memory block has a same size, the memory block groups are located at regular intervals in the address space of the memory, and, within each memory block group, the memory blocks are located at regular intervals in the address space. For example, it is possible that the memory is organized to contain two types of memory block groups so that there is a first set of successively located memory block groups having greater memory blocks and a second set of successively located memory block groups having smaller memory blocks. In this exemplifying case, the above-mentioned formulas (1)-(3) can be applied separately to the first and second sets of memory block groups so that a required address-offset is implemented by giving, in each case, a suitable value to the offset control parameter C.

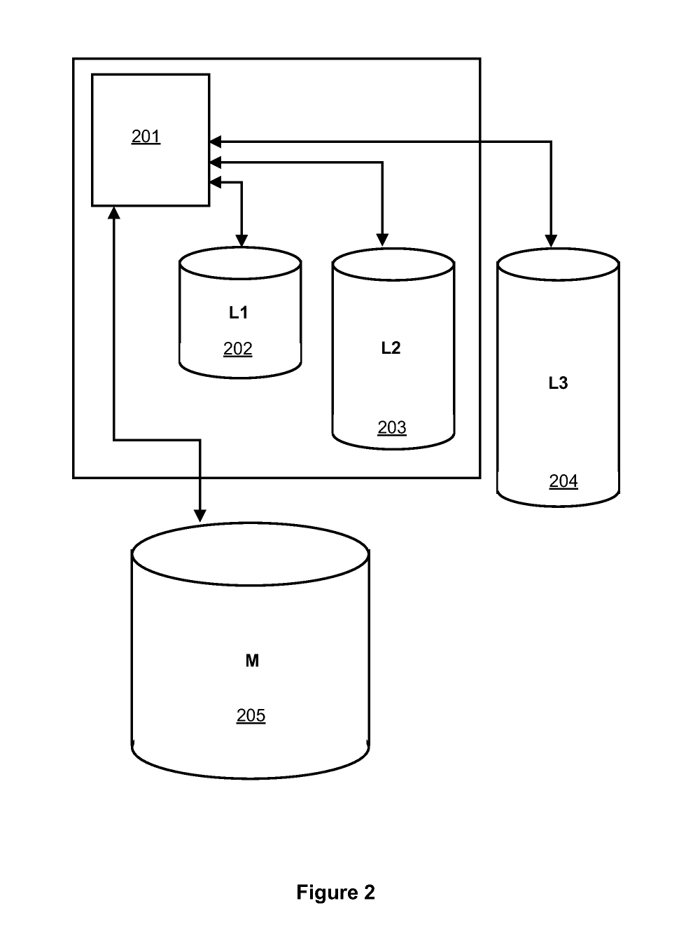

FIG. 2 shows a schematic illustration of a device according to an exemplifying embodiment of the invention for controlling a memory 205 organized to contain a plurality of memory block groups each of which containing a plurality of memory blocks. The device can be, for example but not necessarily, an Internet Protocol “IP” router, an Ethernet switch, and/or a multiprotocol label switching “MPLS” switch. In the following text, the reference numbers whose first digit is ‘1’, e.g. 101, 102, refer to FIG. 1. The device comprises a processor 201 configured to read data from the memory 205. The processor is advantageously configured to use cache memory 202 for speeding up the control of the memory 205. Furthermore, the processor can be configured to operate the second and third level cache memories 203 and 204 in order to compensate the limited capacity of the cache memory 202. The processor 201 is further configured to:
maintain a first data entity 101 containing first data items so that there is a first data item for each of the memory block groups, each of the first data items indicating a number of free memory blocks in the memory block group related to this first data item, and
maintain second data entities 102, 103, 104, . . . , 105 so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity.

The processor 201 is configured to carry out the following actions in response to receiving a request to allocate a free memory block:
searching, from the first data entity 101, such a first data item that indicates that there are one or more free memory blocks in the memory block group related to this first data item,
selecting, from among the second data entities 102, 103, 104, . . . , 105, such a second data entity which is related to the memory block group related to the searched first data item,
selecting, from the selected second data entity, such a second data item which carries an indicator of a free memory block, and
forming an address identifying the free memory block to be allocated at least partly on the basis of (i) the searched first data item which indicates the memory block group having at least one free memory block and (ii) the indicator of the free memory block.

In a device according an exemplifying embodiment of the invention, the processor 201 is configured to carry out the following actions in response to receiving an address identifying a memory block to be released from allocation:
determining the memory block group which contains the memory block to be released,
updating the first data item related to the determined memory block group by adding one to the number of free memory blocks of the determined memory block group,
determining an indicator which identifies, from among the memory blocks of the determined memory block group, the memory block to be released,
determining, from the second data entity related to the determined memory block group, such a second data item which does not contain an indicator of any other memory block that is free, and
setting the determined second data item to contain the indicator which identifies, from among the memory blocks of the determined memory block group, the memory block to be released.

In a device according an exemplifying embodiment of the invention, the processor 201 is configured to:
maintain each of the second data entities 102, 103, 104, . . . , 105 as an ordered list of the second data items belonging to the concerned second data entity,
select, from the selected second data entity, the N^{th} second data item from the end or from the beginning of the ordered list so as to select, from the selected second data entity, such a second data item which carries the indicator of the free memory block, N being the number of free memory blocks in the memory block group related to the searched first data item.

In a device according an exemplifying embodiment of the invention, the processor 201 is configured to carry out the following actions in order to search, from the first data entity 101, such a first data item that indicates that there are one or more free memory blocks in the memory block group related to this first data item:
maintaining the first data entity as a logical ring so that each first data item has a predecessor and a successor in the logical ring,
maintaining a pointer indicating, from the logical ring, such a first data item that relates to the memory block group that contains a previously-allocated memory block, and
proceeding, starting from the first data item indicated by the pointer, on the logical ring as long as such a first data item that indicates that there are one or more free memory blocks in the memory block group related to this first data item is found.

In a device according an exemplifying embodiment of the invention, the processor 201 is configured to carry out the following actions in order to search, from the first data entity 101, such a first data item that indicates that there are one or more free memory blocks in the memory block group related to this first data item:
maintaining the first data entity as an ordered list so that each first data item has a predecessor and/or a successor in the ordered list, and
proceeding, starting from the beginning of the ordered list, on the ordered list as long as such a first data item that indicates that there are one or more free memory blocks in the memory block group related to this first data item is found.

In a device according an exemplifying embodiment of the invention, the processor 201 is configured to maintain a consecutive numbering of the memory block groups and a consecutive numbering of the memory blocks within each memory block group. The processor is configured to form the address Addr₁ identifying the free memory block to be allocated according to the following formula:

Addr₁=k_{BG1}×S_{BG}+k_{B1}×S_{B}+C,

where k_{BG1} is the number of the memory block group related to the searched first data entity, k_{V1} is the number of the free memory block to be allocated, S_{BG} is a difference of mutually corresponding addresses of two successive memory block groups, S_{B} is a difference of mutually corresponding addresses of two successive memory blocks in the memory block group related to the searched first data entity, and C is an offset control parameter which is the value of Addr₁ in the situation where S_{BG}=S_{B}=0.

In a device according an exemplifying embodiment of the invention, the processor 201 is configured to determine the number k_{BG2} of the memory block group, which contains the memory block to be released, according to the following formula:

$${k}_{BG 2} = the integer part of ( \frac{{Addr}_{2} - C}{{S}_{BG}} ) ,$$

where Addr₂ is the address identifying the memory block to be released. The processor 201 is configured to determine the number k_{B2} of the memory block to be released according to the following formula:

$${k}_{B 2} = \frac{{Addr}_{2} - {k}_{BG 2} \times {S}_{BG} - C}{{S}_{B}} .$$

In a device according an exemplifying embodiment of the invention, the processor 201 is configured to:
maintain the first data entity 101 so that the first data entity contains 48 first data items each of which containing four bits, and
maintain the second data entities so that each second data entity comprises 15 second data items each of which containing four bits.

In the above-mentioned exemplifying case, there are 48 memory block groups each containing 15 memory blocks. Each first data item 101 can be four bits because in each memory block group there can be from 0 to 15 free memory blocks and four bits are sufficient for expressing the values from 0 to 15. Each of the second data items 102, 103, 104, . . . , 105 can also be four bits. In this case, the size of the first data entity is 48×4 bits which is 24 bytes, and the size of each second data entity is 15×4 bits which is less than 8 bytes. In a case where a cache line is e.g. 32 bytes, the first data entity 101 fits in a single cache line and four second data entities fit in a single cache line. The whole data structure, i.e. the first data entity and the 48 second data entities, fits in only 13 cache lines. Thus, cache misses are very improbable in allocation and releasing operations, and therefore the cache memory 202 can be effectively utilized.

The processor 201 can be implemented with one or more processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”. Furthermore, it is possible that a first processing circuit is configured to allocate memory blocks and a second processing circuit is configured to release the memory blocks from allocation.

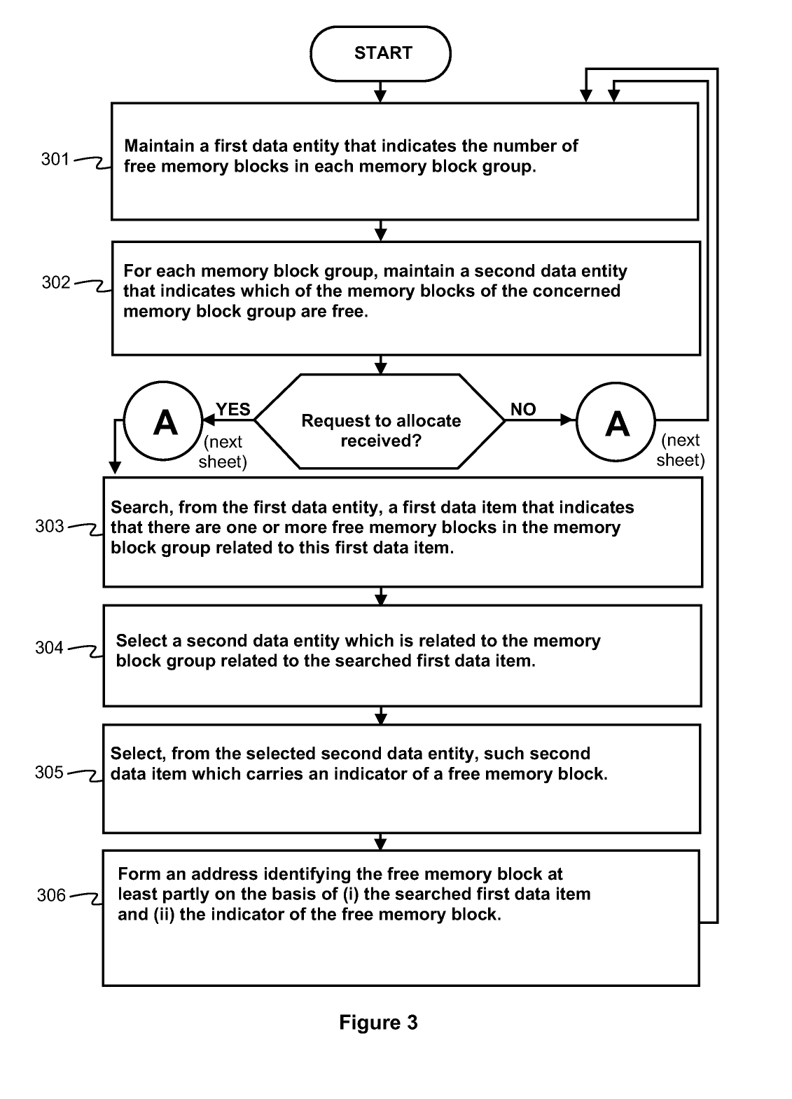

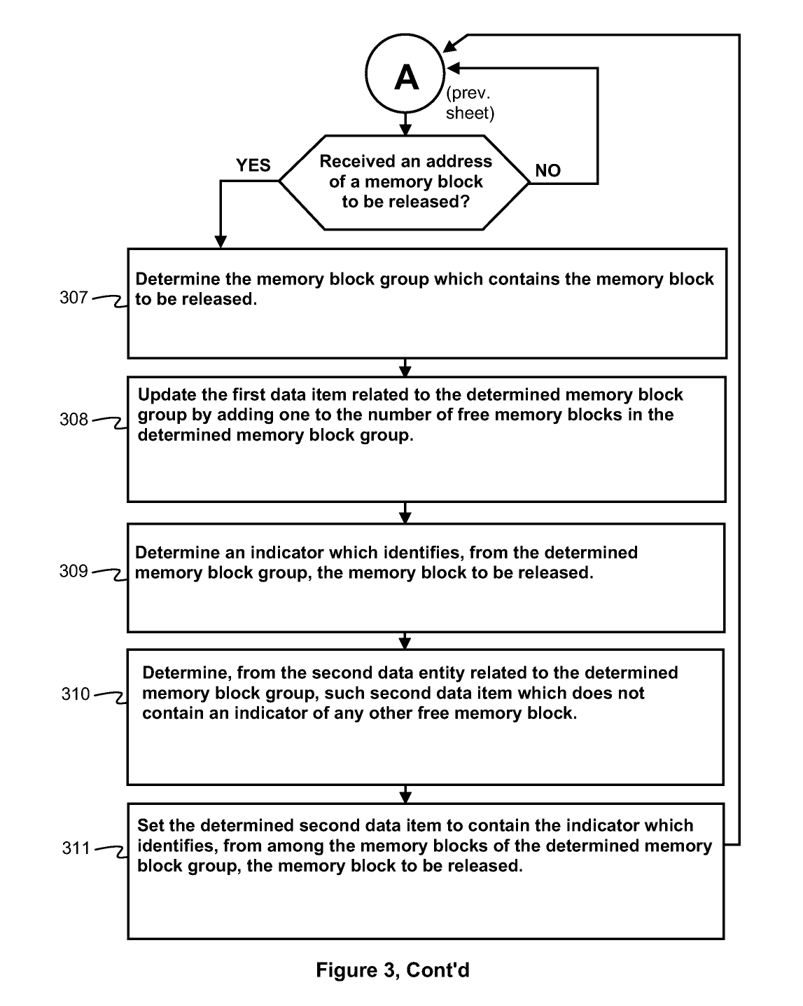

FIG. 3 shows a flow chart of a method according to an exemplifying embodiment of the invention for controlling a memory organized to contain a plurality of memory block groups each of which containing a plurality of memory blocks. The method comprises the following actions:
action 301: maintaining a first data entity containing first data items so that there is a first data item for each of the memory block groups, each of the first data items indicating a number of free memory blocks in the memory block group related to this first data item, and
action 302: maintaining second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity.

The method further comprises carrying out the following actions in response to receiving a request to allocate a free memory block:
action 303: searching, from the first data entity, such a first data item that indicates that there are one or more free memory blocks in the memory block group related to this first data item,
action 304: selecting, from among the second data entities, such a second data entity which is related to the memory block group related to the searched first data item,
action 305: selecting, from the selected second data entity, such a second data item which carries an indicator of a free memory block, and
action 306: forming a first address identifying the free memory block to be allocated at least partly on the basis of (i) the searched first data item which indicates the memory block group having at least one free memory block and (ii) the indicator of the free memory block.

A method according to an exemplifying embodiment of the invention comprises carrying out the following actions in response to receiving an address identifying a memory block to be released from allocation:
action 307: determining the memory block group which contains the memory block to be released,
action 308: updating the first data item related to the determined memory block group by adding one to the number of free memory blocks in the determined memory block group,
action 309: determining an indicator which identifies, from among the memory blocks of the determined memory block group, the memory block to be released,
action 310: determining, from the second data entity related to the determined memory block group, such a second data item which does not contain an indicator of any other memory block that is free, and
action 311: setting the determined second data item to contain the indicator which identifies, from among the memory blocks of the determined memory block group, the memory block to be released.

A method according to an exemplifying embodiment of the invention comprises:
maintaining each of the second data entities as an ordered list of the second data items belonging to the concerned second data entity,
selecting, from the selected second data entity, the N^{th} second data item from the end or from the beginning of the ordered list so as to select, from the selected second data entity, such a second data item which carries the indicator of the free memory block, N being the number of free memory blocks in the memory block group related to the searched first data item.

A method according to an exemplifying embodiment of the invention comprises carrying out the following actions in order to search, from the first data entity, such a first data item that indicates that there are one or more free memory blocks in the memory block group related to this first data item:
maintaining the first data entity as a logical ring so that each first data item has a predecessor and a successor in the logical ring,
maintaining a pointer indicating, from the logical ring, such a first data item that relates to the memory block group that contains a previously-allocated memory block, and
proceeding, starting from the first data item indicated by the pointer, on the logical ring as long as such a first data item that indicates that there are one or more free memory blocks in the memory block group related to this first data item is found.

A method according to an exemplifying embodiment of the invention comprises carrying out the following actions in order to search, from the first data entity, such a first data item that indicates that there are one or more free memory blocks in the memory block group related to this first data item:
maintaining the first data entity as an ordered list so that each first data item has a predecessor and/or a successor in the ordered list, and
proceeding, starting from the beginning of the ordered list, on the ordered list as long as such a first data item that indicates that there are one or more free memory blocks in the memory block group related to this first data item is found.

In a method according to an exemplifying embodiment of the invention, the memory block groups are consecutively numbered and, within each memory block group, memory blocks are consecutively numbered. The address Addr₁ identifying the free memory block to be allocated is formed according to the following formula:

Addr₁=k_{BG1}×S_{BG}+k_{B1}×S_{B}+C,

where k_{BG1} is the number of the memory block group related to the searched first data entity, k_{B1} is the number of the free memory block to be allocated, S_{BG} is a difference of mutually corresponding addresses of two successive memory block groups, S_{B} is a difference of mutually corresponding addresses of two successive memory blocks in the memory block group related to the searched first data entity, and C is an offset control parameter which is the value of Addr₁ in the situation where S_{BG}=S_{B}=0.

In a method according to an exemplifying embodiment of the invention, the number k_{BG2} of the memory block group, which contains the memory block to be released, is determined according to the following formula:

$${k}_{BG 2} = the integer part of ( \frac{{Addr}_{2} - C}{{S}_{BG}} ) ,$$

and the number k_{B2} of the memory block to be released is determined according to the following formula:

$${k}_{B 2} = \frac{{Addr}_{2} - {k}_{BG 2} \times {S}_{BG} - C}{{S}_{B}} ,$$

where Addr₂ is the second address identifying the memory block to be released.

In a method according to an exemplifying embodiment of the invention, the first data entity contains 48 first data items each of which containing four bits, and each second data entity comprises 15 second data items each of which containing four bits.

A computer program according to an embodiment of the invention comprises software modules for controlling a memory organized to contain a plurality of memory block groups each of which containing a plurality of memory blocks. The software modules comprise computer executable instructions for controlling a programmable processor to:
maintain a first data entity containing first data items so that there is a first data item for each of the memory block groups, each of the first data items indicating a number of free memory blocks in the memory block group related to this first data item, and
maintain second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity.

The software modules further comprise computer executable instructions for controlling the programmable processor to carry out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block, and
forming a first address identifying the free memory block to be allocated at least partly on the basis of (i) the searched first data item which indicates the memory block group having at least one free memory block and (ii) the indicator of the free memory block.

In a computer program according to an exemplifying embodiment of the invention, the software modules further comprise computer executable instructions for controlling the programmable processor to carry out the following actions in response to receiving an address identifying a memory block to be released from allocation:
determining the memory block group which contains the memory block to be released,
updating the first data item related to the determined memory block group by adding one to the number of free memory blocks in the determined memory block group,
determining an indicator which identifies, from among the memory blocks of the determined memory block group, the memory block to be released,
determining, from the second data entity related to the determined memory block group, such a second data item which does not contain an indicator of any other memory block that is free, and
setting the determined second data item to contain the indicator which identifies, from among the memory blocks of the determined memory block group, the memory block to be released.

The software modules can be e.g. subroutines or functions implemented with a suitable programming language and with a compiler suitable for the programming language and the programmable processor.

A computer program product according to an embodiment of the invention comprises a computer readable medium, e.g. a compact disc (“CD”), encoded with a computer program according to an embodiment of invention.

A signal according to an embodiment of the invention is encoded to carry information defining a computer program according to an embodiment of invention.

The specific examples provided in the description given above should not be construed as limiting the scope and/or the applicability of the appended claims.

What is claimed is:

1. A device for controlling a memory organized to contain a plurality of memory block groups each of which containing a plurality of memory blocks, the device comprising a processor:
for receiving a request to allocate a free memory block from among the memory blocks of the memory,
for maintaining a first data entity containing first data items so that there is a first data item for each of the memory block groups, each of the first data items indicating how many free memory blocks there are in the memory block group related to this first data item, and
for maintaining second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this sec- and data entity,
wherein the processor is configured to carry out the following actions in response to receiving the request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming a first address identifying the free memory block to be allocated at least partly on the basis of the searched first data item which indicates the memory block group having at least one free memory block and the indicator of the free memory block, and
updating the searched first data item to correspond to a situation in which the number of free memory blocks in the memory block group related to the searched first data item has decreased by one.

2. A device according to claim 1, wherein the processor is configured to carry out the following actions in response to receiving a second address identifying a memory block to be released from allocation:
determining the memory block group which contains the memory block to be released,
updating the first data item related to the determined memory block group to correspond to a situation in which the number of free memory blocks in the determined memory block group has increased by one,
determining an indicator which identifies, from among the memory blocks of the determined memory block group, the memory block to be released,
determining, from the second data entity related to the determined memory block group, such a second data item which does not contain an indicator identifying, from among the memory blocks of the determined memory block group, any memory block that is free and that is other than the memory block to be released, and
setting the determined second data item to contain the indicator which identifies, from among the memory blocks of the determined memory block group, the memory block to be released.

3. A device according to claim 1, wherein the processor is configured to:
maintain each of the second data entities as an ordered list of the second data items belonging to the concerned second data entity,
select, from the selected second data entity, the N^{th} second data item from the end or from the beginning of the ordered list so as to select, from the selected second data entity, such a second data item which carries the indicator of the free memory block, N being the number of free memory blocks in the memory block group related to the searched first data item.

4. A device according to claim 1, wherein the processor is configured to carry out the following actions in order to search, from the first data entity, such a first data item that indicates that there are one or more free memory blocks in the memory block group related to this first data item:
maintaining the first data entity as a logical ring so that each first data item has a predecessor and a successor in the logical ring,
maintaining a pointer indicating, from the logical ring, such a first data item that relates to the memory block group that contains a previously-allocated memory block, and
proceeding, starting from the first data item indicated by the pointer, on the logical ring as long as such a first data item that indicates that there are one or more free memory blocks in the memory block group related to this first data item is found.

5. A device according to claim 1, wherein the processor is configured to carry out the following actions in order to search, from the first data entity, such a first data item that indicates that there are one or more free memory blocks in the memory block group related to this first data item:
maintaining the first data entity as an ordered list so that each first data item has a predecessor and/or a successor in the ordered list, and
proceeding, starting from the beginning of the ordered list, on the ordered list as long as such a first data item that indicates that there are one or more free memory blocks in the memory block group related to this first data item is found.

6. A device according to claim 1, wherein the processor is configured to maintain a consecutive numbering of the memory block groups and a consecutive numbering of the memory blocks within each memory block group, and the processor is configured to form the first address identifying the free memory block to be allocated according to the following formula:
Addr₁=k_{BG1}×S_{BG}+k_{B1}×S_{B}+C,
where Addr₁ is the first address, k_{BG1} is the number of the memory block group related to the searched first data entity, kₘ is the number of the free memory block to be allocated, S_{BG} is a difference of mutually corresponding addresses of two successive memory block groups, S_{B} is a difference of mutually corresponding addresses of two successive memory blocks in the memory block group related to the searched first data entity, and C is an offset control parameter which is the value of Addr₁ when S_{BG}=S_{B}=0.

7. A device according to claim 6, wherein the processor is configured to determine the number of the memory block group, which contains the memory block to be released, according to the following formula:
$${k}_{BG 2} = the integer part of ( \frac{{Addr}_{2} - C}{{S}_{BG}} ) ,$$
and to determine the number of the memory block to be released according to the following formula:
$${k}_{B 2} = \frac{{Addr}_{2} - {k}_{BG 2} \times {S}_{BG} - C}{{S}_{B}} ,$$
where Addr₂ is the second address identifying the memory block to be released, k_{BG2} is the number of the memory block group which contains the memory block to be released, and k_{B2} is the number of the memory block to be released.

8. A device according to claim 1, wherein the processor is configured to:
maintain the first data entity so that the first data entity contains 48 first data items each of which containing four bits, and
maintain the second data entities so that each second data entity comprises 15 second data items each of which containing four bits.

9. A device according to claim 1, wherein the device is at least one of the following: an Internet Protocol “IP” router, an Ethernet switch, a multiprotocol label switching “MPLS” switch.

10. A method for controlling a memory organized to contain a plurality of memory block groups each of which containing a plurality of memory blocks, the method comprising:
maintaining a first data entity containing first data items so that there is a first data item for each of the memory block groups, each of the first data items indicating how many free memory blocks there are in the memory block group related to this first data item, and
maintaining second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity,
wherein the method further comprises carrying out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming a first address identifying the free memory block to be allocated at least partly on the basis of the searched first data item which indicates the memory block group having at least one free memory block and the indicator of the free memory block, and
updating the searched first data item to correspond to a situation in which the number of free memory blocks in the memory block group related to the searched first data item has decreased by one.

11. A method according to claim 10, wherein the method comprises carrying out the following actions in response to receiving a second address identifying a memory block to be released from allocation:
determining the memory block group which contains the memory block to be released,
updating the first data item related to the determined memory block group to correspond to a situation in which the number of free memory blocks in the determined memory block group has increased by one,
determining an indicator which identifies, from among the memory blocks of the determined memory block group, the memory block to be released,
determining, from the second data entity related to the determined memory block group, such a second data item which does not contain an indicator identifying, from among the memory blocks of the determined memory block group, any memory block that is free and that is other than the memory block to be released, and
setting the determined second data item to contain the indicator which identifies, from among the memory blocks of the determined memory block group, the memory block to be released.

12. A method according to claim 10, wherein the method comprises:
maintaining each of the second data entities as an ordered list of the second data items belonging to the concerned second data entity,
selecting, from the selected second data entity, the N^{th} second data item from the end or from the beginning of the ordered list so as to select, from the selected second data entity, such a second data item which carries the indicator of the free memory block, N being the number of free memory blocks in the memory block group related to the searched first data item.

13. A method according to claim 10, wherein the method comprises carrying out the following actions in order to search, from the first data entity, such a first data item that indicates that there are one or more free memory blocks in the memory block group related to this first data item:
maintaining the first data entity as a logical ring so that each first data item has a predecessor and a successor in the logical ring,
maintaining a pointer indicating, from the logical ring, such a first data item that relates to the memory block group that contains a previously-allocated memory block, and
proceeding, starting from the first data item indicated by the pointer, on the logical ring as long as such a first data item that indicates that there are one or more free memory blocks in the memory block group related to this first data item is found.

14. A method according to claim 10, wherein the method comprises carrying out the following actions in order to search, from the first data entity, such a first data item that indicates that there are one or more free memory blocks in the memory block group related to this first data item:
maintaining the first data entity as an ordered list so that each first data item has a predecessor and/or a successor in the ordered list, and
proceeding, starting from the beginning of the ordered list, on the ordered list as long as such a first data item that indicates that there are one or more free memory blocks in the memory block group related to this first data item is found.

15. A method according to claim 10, wherein the memory block groups are consecutively numbered and, within each memory block group, memory blocks are consecutively numbered, and the first address identifying the free memory block to be allocated is formed according to the following formula:
Addr₁=k_{BG1}×S_{BG}+k_{B1}×S_{B}+C,
where Addr₁ is the first address, k_{BG1} is the number of the memory block group related to the searched first data entity, kₘ is the number of the free memory block to be allocated, S_{BG} is a difference of mutually corresponding addresses of two successive memory block groups, S_{B} is a difference of mutually corresponding addresses of two successive memory blocks in the memory block group related to the searched first data entity, and C is an offset control parameter which is the value of Addr₁ when S_{BG}=S_{B}=0.

16. A method according to claim 15, wherein the number of the memory block group, which contains the memory block to be released, is determined according to the following formula:
$${k}_{BG 2} = the integer part of ( \frac{{Addr}_{2} - C}{{S}_{BG}} ) ,$$
and the number of the memory block to be released is determined according to the following formula:
$${k}_{B 2} = \frac{{Addr}_{2} - {k}_{BG 2} \times {S}_{BG} - C}{{S}_{B}} ,$$
where Addr₂ is the second address identifying the memory block to be released, k_{BG2} is the number of the memory block group which contains the memory block to be released, and k_{B2} is the number of the memory block to be released.

17. A method according to claim 10, wherein the first data entity contains 48 first data items each of which containing four bits, and each second data entity comprises 15 second data items each of which containing four bits.

18. A non-transitory computer readable medium encoded with a computer program for controlling a memory organized to contain a plurality of memory block groups each of which containing a plurality of memory blocks, the computer program comprising computer executable instructions for controlling a programmable processor to:
maintain a first data entity containing first data items so that there is a first data item for each of the memory block groups, each of the first data items indicating how many free memory blocks there are in the memory block group related to this first data item, and
maintain second data entities so that there is a second data entity for each of the memory block groups and each of the second data entities contains second data items so that the number of the second data items in each second data entity is at least the number of the memory blocks in the memory block group related to this second data entity, and, when one or more of the memory blocks of the memory block group related to this second data entity are free, one or more of the second data items of this second data entity contain indicators identifying the free memory blocks from among the memory blocks of the memory block group related to this second data entity,
wherein the computer program further comprises computer executable instructions for controlling the programmable processor to carry out the following actions in response to receiving a request to allocate a free memory block:
searching, from the first data entity, such a first data item that indicates that there are one or more free memory blocks in the memory block group related to this first data item,
selecting, from among the second data entities, such a second data entity which is related to the memory block group related to the searched first data item,
selecting, from the selected second data entity, such a second data item which carries an indicator of a free memory block,
forming a first address identifying the free memory block to be allocated at least partly on the basis of the searched first data item which indicates the memory block group having at least one free memory block and the indicator of the free memory block, and
updating the searched first data item to correspond to a situation in which the number of free memory blocks in the memory block group related to the searched first data item has decreased by one.

19. A non-transitory computer readable medium according to claim 18, wherein the computer program further comprises computer executable instructions for controlling the programmable processor to carry out the following actions in response to receiving a second address identifying a memory block to be released from allocation:
determining the memory block group which contains the memory block to be released,
updating the first data item related to the determined memory block group to correspond to a situation in which the number of free memory blocks in the determined memory block group has increased by one,
determining an indicator which identifies, from among the memory blocks of the determined memory block group, the memory block to be released,
determining, from the second data entity related to the determined memory block group, such a second data item which does not contain an indicator identifying, from among the memory blocks of the determined memory block group, any memory block that is free and that is other than the memory block to be released, and
setting the determined second data item to contain the indicator which identifies, from among the memory blocks of the determined memory block group, the memory block to be released.
